(19) United States
(12) Patent Application Publication
(10) Pub. No.: US 2026/0288485 A1
(43) Pub. Date: Sep. 24, 2026

(54) MACHINE-LEARNING MODEL FOR WORKLOAD DETECTION

(71) Applicant: Google LLC, Mountain View, CA (US)

(72) Inventors: Lijun Li, San Diego, CA (US); Xiaoping Xie, Cupertino, CA (US)

(21) Appl. No.: 19/476,418

(22) PCT Filed: Apr. 20, 2023
(86) PCT No.: PCT/US2023/019281

§ 371 Date: Oct. 17, 2025

(51) Int. Cl. G06F 9/445; G06F 15/78

(52) U.S. Cl. CPC G06F 9/44505; G06F 15/7807

(57) ABSTRACT

Methods and systems, including computer-readable media, are described for implementing a workload detection machine-learning (ML) model at an integrated circuit, such as a system-on-chip (“SoC”) of a user device. A request to launch an application is received at the SoC and multiple software indicators are determined based on the request. The software indicators include an app-launch indicator indicating the application was launched at the user device and one or more function call indicators. The workload detection ML model computes inference outputs that can include a detected workload type and quality control values. The quality control values are computed by applying an adaptive ML algorithm of the workload detection ML model to each of the plurality of software indicators. The inference outputs are used to generate a Dynamic Variable Frequency Signal (“DVFS”) control value for controlling DVFS settings at the SoC based at least on the detected workload type.

### BACKGROUND

This specification generally relates to a machine-learning workload detector.

Machine-learning models can employ neural networks with one or more layers of nodes to generate an output, e.g., a classification, for a received input. Some neural networks include one or more hidden layers in addition to an output layer. Some neural networks can be convolutional neural networks (CNNs) configured for image processing or recurrent neural networks (RNNs) configured for speech and language processing.

Different types of machine-learning architectures can be used to perform a variety of tasks related to classification or pattern recognition, predictions that involve data modeling, and information clustering. A neural network layer can have a corresponding set of parameters or weights. The weights are used to process inputs (e.g., a batch of inputs) through the neural network layer to generate a corresponding output of the layer for computing a neural network inference. A batch of inputs and a set of kernels can be represented as respective tensors, i.e., a first multi-dimensional array of inputs and a second, different multi-dimensional array of weights.

A hardware accelerator is a special-purpose integrated circuit for implementing neural networks or other machine-learning models. The integrated circuit can include memory used to store data for multiple tensors. The memory includes individual memory locations that are identified by unique addresses (e.g., virtual or physical addresses). The address locations can correspond to elements of a tensor. Data corresponding to elements of one or more tensors may be traversed or accessed using control logic of the integrated circuit.

### SUMMARY

A workload detector is disclosed for determining a workload type of an application that is launched or executed at a user device. The workload detector uses one or more algorithms to determine the workload type and cooperates with an adaptive learning engine that uses machine-learning algorithms to infer quality control values for each workload type. The workload detector and learning engine can be included in an example dynamic voltage and frequency scaling (“DVFS”) module of a system-on-chip (“SoC”) of a user device. The DVFS module controls DVFS settings of the SoC based on operations performed by the workload detector and learning engine.

The workload detector detects or determines workload type based on a static algorithm, a machine-learning (“ML”) algorithm, or both. Whether static or ML-based, the workload detector leverages a unique detection algorithm to process a set of inputs and generate an output specifying a detected workload type in response to processing the set of inputs. The learning engine receives or obtains the detected workload type as an output of the workload detector. For each workload type, the learning engine uses an adaptive cost function to iteratively adjust the quality control values based on a respective deviation value. Each quality control value corresponds to a quality of service parameter and is a threshold value for determining or detecting a violation of a threshold quality of service (QoS).

Each deviation value represents a violation of a respective QoS parameter. The learning engine cooperates with the workload detector to compute a respective deviation value by evaluating real-time service quality data against a corresponding quality control value. For example, as the user device executes an application (e.g., a game), the workload detector or learning engine (or both) can retrieve a frame loss value that indicates a number of frames that are lost in real-time when displaying a graphical interface of the application at the user device. In this example, the learning engine computes a frame loss deviation value by evaluating the frame loss value against a quality control value for a threshold number of lost frames.

Based on a value, or general magnitude, of the frame loss deviation value, the DVFS module can detect a violation of a threshold QoS parameter for frame loss and generate a QoS violation signal. The violation signal is provided to, and processed by, the adaptive cost function to generate a DVFS control signaling, with one or more control values, as an output of the DVFS module. Thus, the workload detector is used to generate a DVFS control value to dynamically control DVFS settings across IP blocks of the SoC in the user device. In some cases the workload detector and violation signal are also used to iteratively adjust each quality control value.

One aspect of the subject matter described in this specification can be embodied in a computer-implemented method performed using a workload detection machine-learning (“ML”) model implemented at a hardware integrated circuit. The method includes: receiving, at a system-on-chip (“SoC”) of a user device, a request to launch an application at the user device; and determining, based on the request, multiple software indicators. The multiple software indicators include an app-launch indicator that indicates an application was launched at the user device and one or more function call indicators.

The method further includes: computing, by the workload detection ML model, inference outputs including a detected workload type and multiple quality control values. The quality control values are computed by applying an adaptive ML algorithm of the workload detection ML model to each of the multiple software indicators; and generating, using the inference outputs, a Dynamic Variable Frequency Signal (“DVFS”) control value for controlling DVFS settings at the SoC based at least on the detected workload type.

These and other implementations can each optionally include one or more of the following features. For example, in some implementations, the method further includes: for each quality of service (QoS) parameter of multiple QoS parameters: computing a respective deviation value for the QoS parameter; wherein the respective deviation value is computed based on: i) a particular quality control value that corresponds to the QoS parameter, and ii) at least one function call indicator. Generating the DVFS control value can include: generating the DVFS control value based on the respective computed deviation value for a particular QoS parameter.

Computing the inference outputs can include: processing, by the workload detection ML model, ML inputs corresponding to each function call indicator through a hidden layer of the workload detection ML model. The ML inputs are processed through the hidden layer in accordance with the adaptive ML algorithm. In some implementations, the adaptive ML algorithm is an adaptive cost function and the method includes: processing, by the workload detection ML model, ML inputs that include respective deviation values for particular QoS parameters; and iteratively updating, based on the adaptive cost function, one or more of the multiple control values after processing the respective deviation values for particular QoS parameters.

Computing the inference outputs can include: computing an inference output that includes one or more control values that were updated based on the adaptive cost function and at least one of the respective deviation values for particular QoS parameters. In some implementations, each of the one or more function call indicators corresponds to an application programming interface (“API”) call and includes: an openCL API call; an openGL API call; a textureBind API call; and a Vulkan API call.

In some implementations, determining the multiple software indicators includes: determining a device state indicator indicating a power state of a display of the user device, wherein the device state indicator is used to generate a DVFS control value with reference to a background task of the application. Determining the multiple software indicators can also include: determining a device state indicator corresponding to a power state of a display of the user device, wherein a bit value of the device state indicator indicates whether the application is a power-critical application. Generating the DVFS control value can include: generating the DVFS control value based on the bit value of the device state indicator and with reference to a background task of the application.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages. Prior approaches for DVFS adjustments in user devices have a number of deficiencies. For example, existing system-level DVFS policies are: i) not aware of, nor do they account for, workload type when determining signal requirements for outputting application content at a user device; and ii) not aware of QoS factors, such as number of frames per second (“FPS”) required for a given application and associated system-level energy consumption for that application.

The disclosed techniques address one or more deficiencies of the prior approaches by providing a more granular level of control to more efficiently regulate DVFS settings at an SoC of a user device (e.g., a tablet or smartphone). The workload detector of the disclosed DVFS module can detect, infer, or otherwise determine a particular type of workload in response to an application launch at a user device. Relatedly, the DVFS module can infer, predict, or otherwise determine QoS requirements such as FPS, latency, and system-level power constraint based at least on a given workload type.

The DVFS module can execute a comprehensive DVFS framework that leverages adaptive learning to regulate DVFS settings at the SoC. The workload type outputs that are generated by the workload detector are passed to the DVFS framework and used to more efficiently adjust DVFS settings, for example, to achieve the lowest, fastest operating points. For example, when executing an application, the DVFS module can be used to determine operating points at the SoC that maximize duty cycle and optimize quality of service. The DVFS settings can be used to achieve a threshold level of performance while also minimizing the resource overhead required to achieve that performance level.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system of a system-on-chip.

FIG. 2 shows an example workload type detection algorithm.

FIG. 3 shows an example flow diagram for determining a quality of service deviation for a particular workload type.

FIG. 4 shows an example adaptive ML training/self-learning engine.

FIG. 5 is an example process for workload detection using the computing system of FIG. 1.

Like reference numbers and designations in the various drawings indicate like elements.

### DETAILED DESCRIPTION

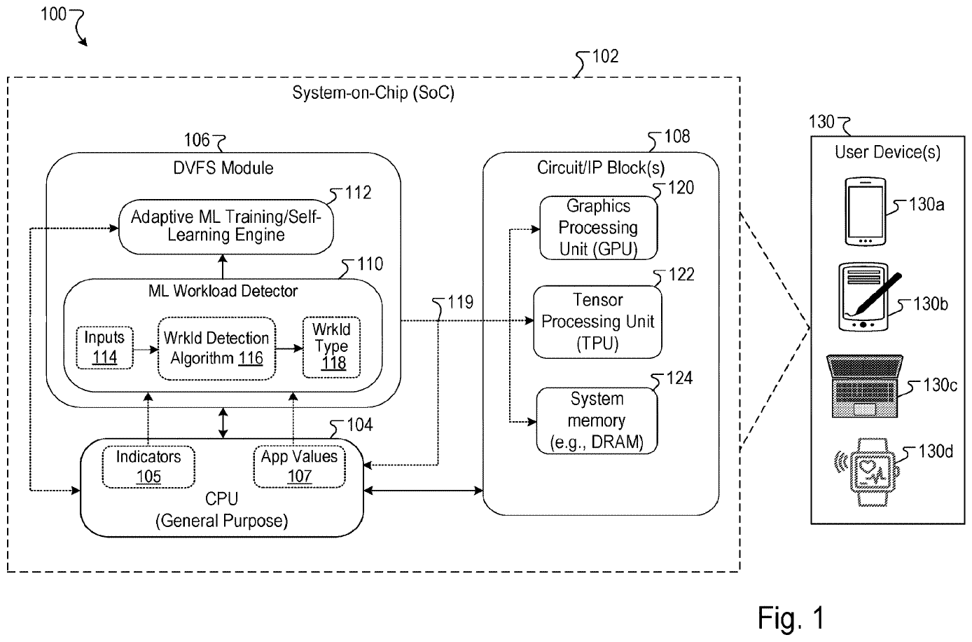

FIG. 1 is a block diagram of an example computing system 100 that includes a system-on-chip 102 (“SoC 102”). The SoC 102 includes a central processing unit 104 (“CPU 104”), a dynamic voltage and frequency scaling (“DVFS”) module 106, and a circuit block 108.

The CPU 104 generates one or more indicators 105, such as an app-launch indicator or a function call that is triggered in response to executing or launching an application at a user device. The CPU 104 also generates one or more application values 107. The application values 107 may be associated with a function call, may be descriptive of an event that occurs during execution of the application, or both.

The CPU 104 can be a general purpose CPU (e.g., a single or multi-core CPU). The DVFS module 106 can be implemented in software, hardware, or both. In some implementations, the DVFS module 106 is implemented as a software module of the CPU 104 that uses one or more hardware resources of the CPU 104. In some examples, the CPU 104 is configured as an instruction and vector data processing engine that processes data obtained from a system memory of the SoC 102.

The DVFS module 106 includes, or is configured to access, a workload detector 110 and an adaptive ML training/self-learning engine 112 (“adaptive learning engine 112”). The DVFS module 106 is implemented in software, hardware, or both. Aspects of the DVFS module 106 can be also implemented as firmware of the SoC 102 or a device of the SoC 102. As described in detail below, the DVFS module 106 is configured to generate control signaling that is used to regulate voltage (or current) and frequency settings (“DFVS settings”) for system 100.

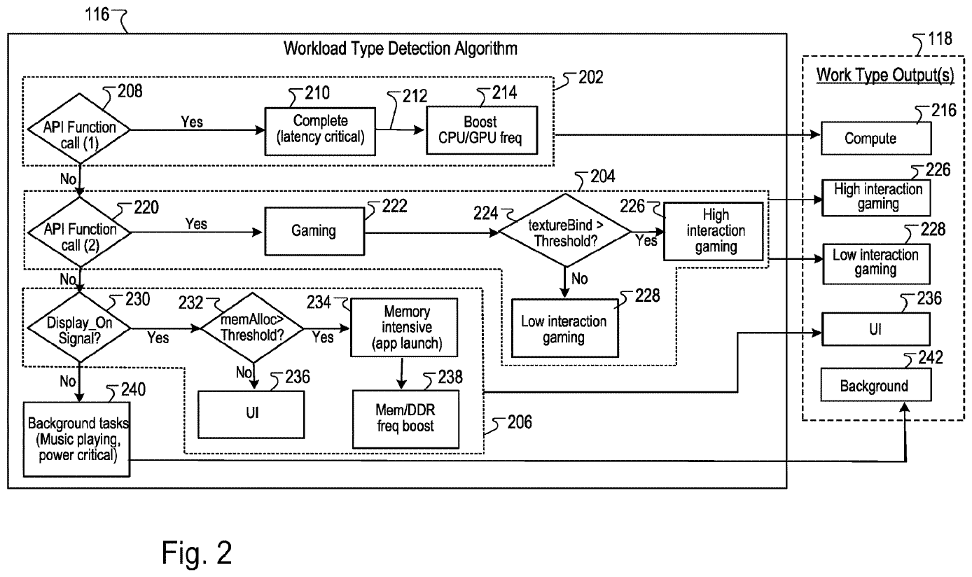

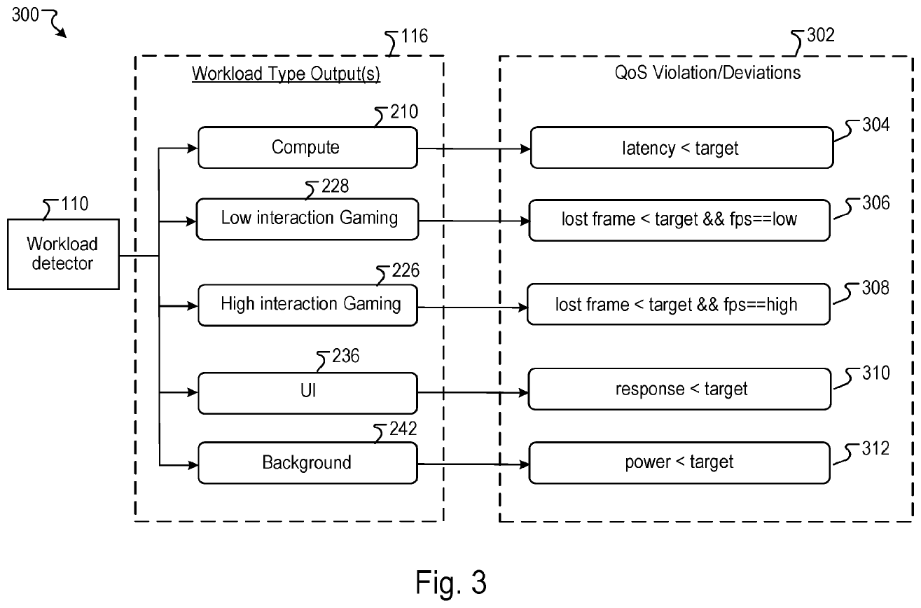

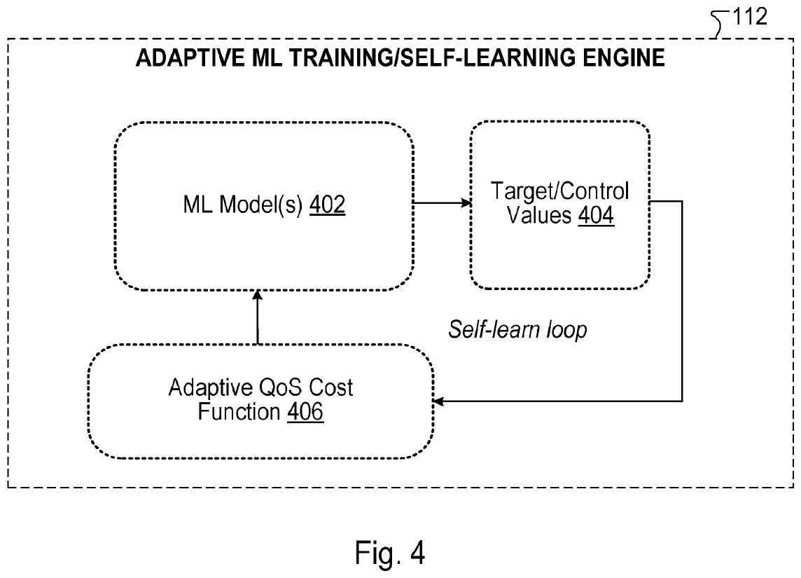

The workload detector 110 receives inputs 114 corresponding to indicators 105 and application values 107. The workload detector 110 processes the inputs 114 using an example workload detection algorithm 116 to generate one or more workload types 118. This is described below with reference to FIG. 2. The adaptive learning engine 112 uses an adaptive cost function to iteratively adjust QoS parameters of the DVFS module 106. This is described below with reference to FIG. 3 and FIG. 4.

The IP block 108 can include a graphics-processing unit (GPU) 120, a tensor processing unit (TPU) 122, and system memory 124. The circuit block 108 is referred to alternatively as an IP block 108, where the IP block can include one or more proprietary hardware elements. For example, each of the GPU 120, TPU 122, and memory 124 can be a proprietary IP block of a particular entity or device manufacturer.

In the example of FIG. 1 system memory 124 is depicted in IP block 108. However, system memory 124 can include memory that is: i) specific to IP block 108, ii) external to IP block 108, or iii) both. In some implementations, the system memory 124 is an example random access memory of the SoC 102, such as a dynamic random access memory (DRAM), a synchronous DRAM (SDRAM), or double data rate (DDR) SDRAM. In some other implementations, memory 124 can be or include various other types of memory, such as high bandwidth memory (HBM), a narrow memory (e.g., for storing 8-bit values), wide memory (e.g., for storing 16-bit or 32-bit values), etc.

In the example of FIG. 1, system 100 and the SoC 102 is an integrated circuit of an example user/client device, consumer electronic device, or mobile device, where each of these devices can include items such as a smartphone 130a, tablet 130b, laptop 130c, smartwatch or wearable device 130d. The devices may also include other items such as an eNotebook, Netbook, smart speaker, or mobile computer. In some implementations, the system 100 and the SoC 102 is an integrated circuit of a desktop computer, network server, or related cloud-based asset.

The DVFS module 106 uses operations performed by the workload detector 110 and adaptive learning engine 112 to dynamically control DVFS settings across the SoC 102, including the CPU 104 and IP blocks 108. More specifically, the DVFS module 106 is configured to generate control signaling 119 and use one or more discrete control values of the control signaling 119 to regulate at least the voltage, current, and frequency values that are included among the DFVS settings of at least the IP blocks 108, the CPU 104, or both.

For example, the control signaling 119 can include at least one control value for regulating DVFS settings at the GPU 120, at least one control value for regulating DVFS settings at the TPU 122, at least one control value for regulating DVFS settings at the system memory 124, and at least one control value for regulating DVFS settings at the CPU 104. In some implementations, each processor (e.g., a CPU, GPU, or TPU) of the SoC 102 includes multiple cores and the DVFS module 106 can generate control signaling 119 to regulate or adjust DVFS settings at each core of the processor.

FIG. 2 shows an example workload type detection algorithm 116 (“algorithm 116”) executed by the workload detector 110. The workload detector 110 can detect or determine workload types based on a static algorithm, a machine-learning (“ML”) algorithm, or both. Whether static or ML-based, the workload detector 110 leverages a unique detection algorithm 116 to generate an output specifying a detected workload type 118.

In some implementations, algorithm 116 represents a process, procedure, or set of rules for performing computations or other problem-solving operations executed by the DVFS module 106, the workload detector 110, or both. As indicated below, the process, procedure, or set of rules may correspond to one or more compute flows. To the extent algorithm 116 is described as performing an action, e.g., detecting, determining, executing, or generating, such actions are performed based on execution of algorithm 116 by the DVFS module 106, the workload detector 110, or other devices of system 100.

As described above, the workload detector 110 processes the inputs 114 in accordance with the algorithm 116 to generate one or more workload types 118. In general, the workload detector 110 initiates its operations to detect a workload type in response to detecting or determining that an application has been launched or executed at user device 130. The detectable workload types include a compute workload type, a high-interaction gaming workload type, a low-interaction gaming workload type, a user-interface workload type, and a background workload type.

The types of workloads detected by the workload detector 110 are specific workloads that are processed by system 100 to generate an application output, such as graphical content rendered at a display of the user device 130. For example, the application can be a gaming application, such as a first-person shooter game or a first-person racing/driver game. In this example, gaming sequences of the application are rendered at a display of user device 130 using one or more resources of the IP blocks 108.

The algorithm 116 can include one or more compute flows 202, 204, 206 for at least a subset of the workload types that are detectable by the workload detector 110. At compute flow 202 the algorithm 116 determines whether a first API function call is detected or triggered (208). The first API function call can be one or more software indicators (or software hints) that indicate a particular workload is compute intensive, has sensitivities to high/long latency, and/or is required to be executed with low latency or within a threshold time duration. The first API function call can include one or more of an OpenCL API call, an OpenGL API call, or a Vulkan API call.

In general, OpenCL is an API call that can be issued at the SoC 102 to execute computations using one or more computational resources of system 100, such as the TPU 122, whereas OpenGL and Vulkan are respective API calls that can be issued at the SoC 102 to execute certain graphical operations using one or more graphics processing resources of system 100, such as the GPU 120. For example, the OpenGL is applied at the SoC 102 to generate user interface (UI) animations, manage embedded video functions, or build vector graphics for rending visual elements of a given application.

The API function calls can be managed by the CPU 104. In some implementations, each API function call is, or corresponds to, a software indicator that is generated by the CPU 104, detected by the CPU 104, or both. Thus, algorithm 116 can make determinations about the first API function call based on one or more indicators 105 detected by the CPU 104. If algorithm 116 determines that a first API function call was detected or triggered, then algorithm 116 determines that the workload is a compute heavy workload (210). If algorithm 116 determines that a first API function call was not triggered, then the algorithm 116 transitions to compute flow 204.

In response to determining that the workload is a compute heavy workload, the algorithm 116 causes the DVFS module 106 or the CPU 104 to generate a control signal 212. More specifically, the algorithm 116 (or workload detector 110) can determine that a workload of the application is a compute workload 216 based on a determination that the first API function call was detected, in response to generating control signal 212, or both. The control signal 212 is used to boost one or more operating frequencies (214) of at least the CPU 104, the GPU 120, or both. In some implementations, the control signal 212 is used to boost a respective operating frequency of other resources of the SoC 102.

In some implementations, using the algorithm 116, the DVFS module 106 determines that the compute heavy workload is latency critical or involves one or more operations that are latency critical. In this implementation, the control signal 212 corresponds to a DVFS control signal that is passed to a resource of the SoC 102 (e.g., the GPU 120) to boost a particular DVFS setting (e.g., frequency) of that resource. The DVFS module 106 boosts the particular DVFS setting to ensure the latency-critical, compute-heavy workload can meet or exceed the required latency (e.g., low-latency) when the workload is executed by the SoC 102.

At compute flow 204 the algorithm 116 determines whether a second API function call is detected or triggered (220). The second API function call can be one or more software indicators (or software hints) that indicate a particular workload is graphics intensive, has sensitivities to lost frames or frame rate, and/or is required to render graphical content with sufficient detail, resolution, or both. The second API function call can include at least a textureBind API call or other related API calls that are used to render graphical content, including textures and other details of that graphical content. In some implementations, the second API function call(s) can include one or more of the API function calls that were described above with reference to the first API function call.

In general, textureBind is an API call that can also be issued at the SoC 102 to execute certain graphical operations using one or more graphics processing resources of system 100, such as the GPU 120. More specifically, textureBind can refer to, or indicate movement of, a scene or avatar that triggers texture changes in graphical content generated for an application. The texture changes are signaled by a textureBind call and one or more values of the textureBind call are used to determine and/or generate a high-interaction parameter signal to indicate a high-interaction gaming mode.

In some implementations, the high-interaction parameter signal is used or processed at the workload detector 110 to indicate that one or more gaming scenes or gaming content has a high FPS requirement or at least an FPS that is required to be above a particular threshold. Examples of a high FPS requirement can vary depending on the type of user device 130 (e.g., smartphone or laptop) as well as other factors such as a screen refresh rate of the user device 130 or a resolution of the device's display. A maximum FPS of a user device 130 can be limited by a screen refresh rate of a display screen of the device. For example, if user device 130 is a mobile/smart phone, then a typical refresh rate of its screen can range from 240 Hz or 120 Hz. So, in this example, the maximum FPS will be up to 120 or 240. In some cases, a high FPS is determined relative to a given resolution, such as 1280×800 or 1280×32.

The workload detector 110 uses algorithm 116 to execute a comparative operation that assesses an example incoming textureBind value against a threshold value. In some implementations, the threshold value is adaptive or dynamically determined at system 100. Example textureBind threshold values can vary (e.g., 1000 or 1200) depending on the gaming application or workload. The comparative operation is executed to determine if an application, or a workload associated with the application, is a high-interaction gaming workload or low-interaction gaming. The second API function calls can be also managed by the CPU 104. In some implementations, the second API function call is, or corresponds to, a software indicator that is generated by the CPU 104, detected by the CPU 104, or both. Thus, algorithm 116 can make determinations about the second, different API function call based on one or more indicators 105 detected by the CPU 104.

If algorithm 116 determines that a second API function call was detected or triggered, then algorithm 116 determines that the workload is a gaming workload (222). If the algorithm 116 determines that a textureBind API call was not triggered, then the algorithm 116 transitions to compute flow 206.

In response to determining that the workload is a gaming workload, the algorithm 116 determines whether a textureBind value exceeds a threshold value. This determination is described above with reference to the comparative operation involving the incoming textureBind value and the textureBind threshold. If algorithm 116 determines that a textureBind value exceeds a threshold value, then algorithm 116 detects or determines that the workload is a high-interaction gaming workload 226. However, if the algorithm 116 determines that a textureBind value does not exceed the threshold value, then the algorithm 116 detects or determines that the workload is a low-interaction gaming workload 228.

When the workload detector 110 determines that the workload is a high-interaction gaming workload 226, the algorithm 116 causes the DVFS module 106 or the CPU 104 to generate a control signal that boosts one or more operating frequencies of at least the GPU 120. This control signal can be also used to boost a respective operating frequency of other resources of the SoC 102. In some instances, this control signal corresponds to the high-interaction parameter signal described above.

In some implementations, using the algorithm 116, the DVFS module 106 determines that the high-interaction gaming workload 226 is a frame-critical workload, a frame-rate critical workload, or involves one or more operations that are particularly sensitive to missed, dropped, or lost frames. In this implementation, the high-interaction parameter signal corresponds to a DVFS control signal that is passed to a resource of the SoC 102 (e.g., the GPU 120) to boost a particular DVFS setting (e.g., frequency) of that resource. The DVFS module 106 boosts the particular DVFS setting to ensure the frame-critical, high-interaction workload can meet or exceed the target requirement for lost frames when the workload is executed at the SoC 102.

At compute flow 206 the algorithm 116 determines whether a display_on signal is detected or triggered (230). In some implementations, the display_on signal is, or corresponds to, a software indicator that is generated by the CPU 104, detected by the CPU 104, or both. Thus, algorithm 116 can make determinations about the display_on signal based on one or more indicators 105 detected by the CPU 104. For example, the display_on signal can be a software indicator (or software hint) that indicates a device state of a user device 130, such as whether a screen or display of the user device is on or off.

If the workload detector 110 determines that a display_on signal was detected or triggered, then the algorithm 116 determines whether a detected memory allocation is greater than a threshold memory allocation (232). If algorithm 116 determines that a display_on signal was not detected or triggered, then algorithm 116 causes the workload detector 110 to generate an output specifying a detected workload type is a background workload. This is described in more detail below.

If the detected memory allocation exceeds a threshold memory allocation, then the workload detector 110 determines that a workload associated with an application is memory intensive (234) user interface (UI) workload. If the detected memory allocation does not exceed a threshold memory allocation, then the workload detector 110 (or the algorithm 116) determines that a workload associated with an application is a non-memory intensive UI workload (236), such as a workload to generate UI elements that is not particularly memory intensive.

In some implementations, to determine that a workload is memory intensive, the workload detector 110 receives a memory allocation input (e.g., mem_alloc) and analyzes or otherwise uses that memory allocation input to determine whether the workload is a memory intensive or non-memory intensive workload. The memory allocation input may be among the software indicators 105 detected (or generated) by the CPU 104. In some implementations, the memory allocation information is provided by, or obtained from, an operating system (OS) kernel.

If or when the workload detector 110 determines that a workload or application is memory intensive (234), then the workload detector 110 (or algorithm 116) causes the DVFS module 106 or the CPU 104 to generate a control signal that boosts one or more operating frequencies (238) of at least the system memory 124. This control signal can be also used to boost a respective operating frequency of other resources of the SoC 102. For example, this control signal can be used to boost frequencies for a memory interface to expedite obtaining certain data, such as data produced by the CPU 104 for specific gaming application drivers.

In some implementations, a control signal that boosts an operating frequency of system memory 124 represents a RAM/DDR frequency boost signal and the DVFS module 106 (or the CPU 104) can generate multiple memory frequency boost signals. The system memory 124 can include multiple DDR/DRAM modules and each RAM/DDR boost signal can be used to boost a respective operating frequency of a corresponding DDR/DRAM module. For example, an operating frequency of the system memory 124 can be boosted from 900 MHz to 1.2 GHz.

For context, a particular application, such as a gaming app, that is launched at user device 130 can have processing and graphics resource requirements that sometimes cause a bottleneck on the CPU 102. For example, the CPU 102 may manage executing or running drivers for a gaming application, such that the CPU 102 is both a consumer and producer of data required to execute the application (or a workload) at user device 130. When the CPU 104 is a producer of data it may be required to forward data for initial or further processing via a resource of the IP block 108, such as the GPU 120.

If a particular workload or application is determined to be memory intensive, then the CPU 104 can be required to produce and feed data corresponding to multiple memory allocations (e.g., a large amount of data) to a specific resource of the IP block 108. In some implementations, for certain graphical user interface (GUI) operations that require a fast CPU response time, the CPU 104 is required to produce and feed a large amount of data rapidly to the GPU 120 or TPU 122.

In this implementation, the CPU 104 can become a bottleneck for the compute flow if the CPU 104 feeds the information to the GPU too slowly. This is especially true for workloads or applications that are memory intensive. So, as described above, using algorithm 116, the workload detector 110 causes the DVFS module 106 to generate a control signal that boosts or otherwise adjusts one or more operating frequencies (238) of memory modules at the system memory 124. The frequency can be increased to expedite obtaining and forwarding data required to execute memory intensive workloads of an application.

In general, launching an application at user device 130 triggers or requires an allocation of memory resources, such as buffers, registers, cache, main memory, etc. For example, in response to detecting an app_lauch signal, the CPU 104 can use an allocation signal (e.g., alloc page) to process an application's request for memory. In some implementations, the memory allocation required to execute an application workload is proportional to a number of API function calls. The workload detector 110 can determine a weighting between at least a relative size of the requested memory allocation and number of API function calls, and determine a workload type based on the determined weighting.

As noted above, if the algorithm 116 determines that a display_on signal was not detected or triggered, then the algorithm 116 transitions from compute flow 206 to a background compute flow 240 and causes the workload detector 110 to generate an output specifying a detected workload type is a background workload 242. In some implementations, the background workload 242 involves one or more background tasks. The background workload 242 can be an example non-GUI workload that involves a display_off device state.

For example, during execution of the application, its underlying background workload 242 involves tasks where a display or screen of user device 130 can be turned-off without impacting execution of the application, the workload, or discrete tasks of the workload. In some implementations, the application itself, or a task of the background workload 242, is for receiving text messages, tracking alarm conditions of an alarm clock, or some other action that requires power but requires a minimal processing and memory resources.

Based on algorithm 116, the workload detector 110 can detect or determine that an application or background workload 242 is a power-critical app (or workload). For example, the workload detector 110 can detect or determine a device state indicator corresponding to a power state of a display of the user device 130. In some implementations, a bit value of the device state indicator indicates whether the application is a power-critical application. Using this detection, the DVFS module 106 can determine that establishing or preserving a low-power state is a main priority of the SoC 102.

The device state indicator is used to generate a DVFS control value with reference to a background task of the application or workload. More specifically, the DVFS control signaling 119 can include a DVFS control value generated based on the bit value of the device state indicator and with reference to a background task of the application. For example, the DVFS module 106 can generate a DVFS control signal 119 that is passed to resources of the SoC 102 (e.g., the IP block 108) to establish low-power DVFS settings (e.g., voltage, current, frequency, etc.), for example, by reducing operating voltages and frequencies across the SoC 102.

FIG. 3 shows an example flow diagram for a deviation module 300 used to determine a QoS violation (or deviation) for a particular workload type. As described above, the workload detector 110 is configured to detect multiple types of workloads 118. For a given application, the workload detector 110 can detect or determine at least a compute workload 210, a high-interaction gaming workload 226, a low-interaction gaming workload 228, a UI/GUI workload 234, and a background workload 242.

The deviation module 300 includes comparator logic 302, which comprises multiple comparators. More specifically, the comparator logic 302 includes a latency comparator 304, a first frame comparator 306, a second frame comparator 308, a UI response comparator 310, and a power comparator 312. The latency comparator 304 compares a detected or observed latency to a target latency and generates a QoS violation if the observed latency is less than the target. An example target latency can be 200 milliseconds (ms) or 300 ms.

The first frame comparator 306 compares: i) a detected or observed lost frame value to a target lost frame value and ii) a detected or observed fps to a target fps (e.g., low). The first frame comparator 306 generates a QoS violation if the observed lost value is less than the target and if the observed fps is not equal to the target fps. Similarly, the second frame comparator 308 compares: i) a detected or observed lost frame value to a target lost frame value and ii) a detected or observed fps to a target fps (e.g., high). The second frame comparator 308 generates a QoS violation if the observed lost value is less than the target and if the observed fps is not equal to the target fps.

The UI response comparator 310 compares a detected or observed UI response to a target response and generates a QoS violation if the observed UI response is less than the target. The power comparator 312 compares a detected or observed power value to a target power and generates a QoS violation if the observed power values are less than the target.

FIG. 4 shows an example adaptive ML training/self-learning engine 112. The adaptive learning engine 112 includes one or more machine-learning models 402, one or more adaptive, a set of control values 404, and QoS cost functions 406. The QoS cost function 406 is used to measure, evaluate, or otherwise determine the performance of ML models for a given data set. At least one of the machine-learning models 402 can be implemented using an artificial neural network with multiple layers, including one or more hidden layers.

In some implementations, the QoS cost function 406 quantifies an error between predicted and expected values. The predicted and expected values can be represented by inference outputs of the ML models 402. For example, DVFS module 106 is configured to compute inference outputs using the workload detector 110, the adaptive learning engine 112, or both. The inference outputs can include a detected workload type (e.g., high interaction gaming workload) and multiple quality control values 404, such as a target value for frame per second (fps). To compute the inference outputs, the DVFS module 106 can process ML inputs corresponding to each function call indicator through a hidden layer (e.g., a neural network layer) of at least one ML model 402. For example, the ML inputs can be processed through the hidden layer in accordance with the adaptive ML algorithm.

The quality control values can be computed by applying an adaptive ML algorithm to some (or all) of the software indicators 105, the application values 107, or both. The quality control values 404 can be threshold values for enforcing certain quality of service requirements, such as ensuring an image post-processing operation is computed as fast as possible (e.g., minimal latency) or that a gaming application iterates through multiple scene changes without dropping a single frame.

The adaptive learning engine 112 can use an adaptive QoS cost function 406 to generate an output (e.g., a real number) representing the quantified error. The adaptive learning engine 112 can also use the QoS cost function 406 to iteratively adjust control values for QoS parameters of the DVFS module 106. The control values include target values and a corresponding threshold value for each target value. In one or more examples, a target value and a threshold value can be the same value. The QoS parameters correspond to the one or more detectable workload types and include parameters such as latency, power, lost/missed frames, frame rate, and UI response time. Other parameters relating to application performance and determining DVFS settings are also within the scope of this disclosure.

The adaptive learning engine 112 uses the QoS cost function 406 to compute a respective deviation value for a QoS parameter. For example, a respective deviation value can be computed based on a particular quality control value 404 that corresponds to the QoS parameter and at least one of: i) one or more function call indicators and ii) one or more application values 107. The self-learn loop of the adaptive learning engine 112 is leveraged to compute inference outputs that include one or more control values 404 that were previously updated based on: i) the adaptive cost function 406 and ii) at least one of the respective deviation values for particular QoS parameters.

The adaptive learning engine 112 can include multiple QoS cost functions 406, where each QoS cost function 406 may correspond to one or more ML models 402. For example, the adaptive learning engine 112 can include an ML model 402 and an adaptive QoS cost function 406 for each workload type that is detectable by the workload detector 110. The adaptive learning engine 112 is configured to dynamically determine control values, including thresholds, for each QoS parameter based on the one or more ML models and corresponding QoS cost function 406. In some implementations, the DVFS module 106 is configured as an workload detection ML model that generates DVFS control values based on one or more inference outputs.

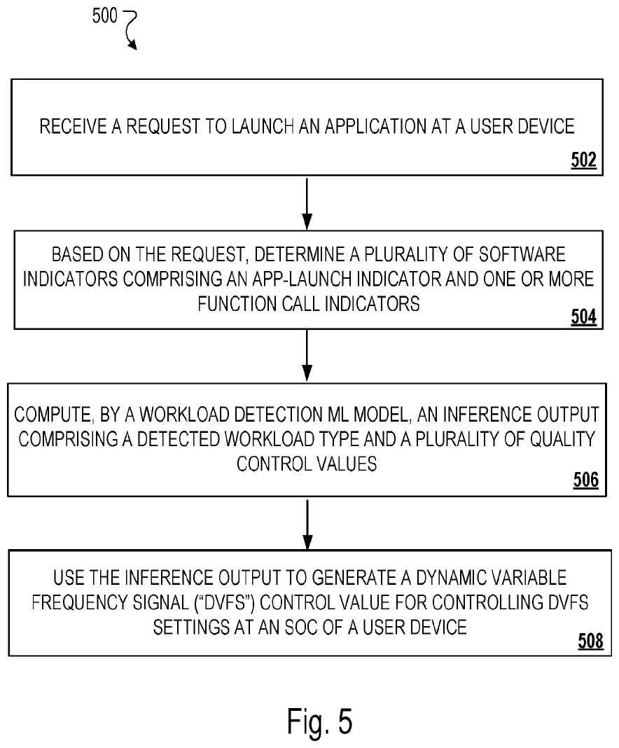

FIG. 5 is an example process 500 for workload detection and adjusting DVFS settings using the computing system of FIG. 1. One or more steps of process 500 are performed to determine one or more attributes of an application workload using a workload detector of a DVFS module. More specifically, the workload detection and adjusting of the DVFS settings are performed based on a workload detection machine-learning (“ML”) model that is implemented at the workload detector 110, the DVFS module 106, or both.

In general, process 500 can be implemented or executed using system 100 and the SoC 102 described above. Hence, descriptions of process 500 may reference the above-mentioned computing resources of system 100 and SoC 102. In some examples, the steps or actions of process 500 are enabled by programmed software instructions, firmware instructions, or both. Each type of instruction may be stored in a non-transitory machine-readable storage device and is executable by one or more of the processors or other resources described in this document, such as the CPU 104, a scalar core or compute tile of the TPU 122, a hardware ML accelerator, or a neural network processor.

In some implementations, the steps of process 500 are performed at a hardware integrated circuit to generate a machine-learning (ML) output, including an output for a neural network layer of a neural network that implements one or more ML models. For example, the output can be a portion of a computation for a ML task or inference workload to generate an image processing, speech processing, or image recognition output. As indicated above, the integrated circuit can be a special-purpose neural network processor or hardware ML accelerator configured to accelerate computations for generating different types of data processing outputs.

Referring again to process 500, the system 100 receives a request to launch an application at a user device (502). More specifically, an SoC 102 of a user device such as user 130a/b/c receives a request to launch an application at the user device 130. For example, the user device 130 can receive an input request from a user to launch a gaming application, such as Halo® or Call of Duty®. The system 100 identifies, detects, or otherwise determines one or more software indicators 105 based on the request (504). The multiple software indicators 105 can form a set of inputs 114 that include an app-launch indicator and one or more function call indicators. As the name implies, the app-launch indicator indicates that an application has been launched at the user device 130.

The workload detection ML model computes an inference output comprising a detected workload type and multiple quality control values (506). For example, the workload detection ML model computes the inference output by applying an adaptive ML algorithm of the workload detection ML model to each of the software indicators 105. In some implementations, the workload detection ML model uses one or more of compute flows 202, 204, 206 to compute or generate the inference output. For example, an output of the compute flow 202 can be an indication that an application workload is a compute workload 216. The workload detector 110 uses this indication to generate and output a workload_type signal that specifies the detected type of the workload.

The system 100 uses the inference output to generate a Dynamic Variable Frequency Signal (“DVFS”) control value (508). In some implementations, the workload detector 110 passes a detected workload type 118 as an output signal to the adaptive ML training/self-learning module 112. For example, the workload detector 110 can pass the detected workload type 118 along with one or more application values 107 or cause the CPU 104 to pass the one or more application values 107. The DVFS module 106 uses the inference output to generate a DVFS control value.

The DVFS control value is for controlling DVFS settings at the SoC 102 based at least on the detected workload type 118. For example, the workload detector 110 can determine that a workload associated with an application is a high-interaction gaming workload and system 100 can use the DVFS control value to control DVFS settings of the GPU 120 to minimize or eliminate frame loss at the user device 130 as the application transitions through different scenarios of the high-interaction game. In some implementations, the DVFS settings are controlled in a manner that allows users to play high interaction gaming applications at user device 130 with minimal (or no) frame loss.

In another example, the workload detector 110 can determine that a workload associated with a music streaming application is a background workload that is operable to output audio streams irrespective of a device state associated with a display/screen of user device 130. The system 100 can use the DVFS control value to control DVFS settings of one or more processor cores of the SoC 102 to minimize power consumption at the user device 130. In some implementations, the DVFS settings are controlled in a manner that allows users to play high interaction gaming applications at user device 130 with minimal (or no) frame loss

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method performed using a workload detection machine-learning (“ML”) model implemented at a hardware integrated circuit, the method comprising:
receiving, at a system-on-chip (“SoC”) of a user device, a request to launch an application at the user device;
determining, based on the request, a plurality of software indicators, the plurality of software indicators comprising an app-launch indicator indicating launch of the application at the user device and one or more function call indicators;
computing, by the workload detection ML model, inference outputs comprising a detected workload type and a plurality of quality control values, wherein the plurality of quality control values is computed by applying an adaptive ML algorithm of the workload detection ML model to each of the plurality of software indicators; and
generating, using the inference outputs, a Dynamic Variable Frequency Signal (“DVFS”) control value for controlling DVFS settings at the SoC based at least on the detected workload type.

2. The method of claim 1, further comprising:
for each quality of service (QoS) parameter of a plurality of QoS parameters:
computing a respective deviation value for the QoS parameter;
wherein the respective deviation value is computed based on:
i) a particular quality control value that corresponds to the QoS parameter, and
ii) at least one function call indicator.

3. The method of claim 2, wherein generating the DVFS control value comprises:
generating the DVFS control value based on the respective deviation value for a particular QoS parameter.

4. The method of claim 2, wherein computing the inference outputs comprises:
processing, by the workload detection ML model, ML inputs corresponding to each function call indicator through a hidden layer of the workload detection ML model,
wherein the ML inputs are processed through the hidden layer in accordance with the adaptive ML algorithm.

5. The method of claim 4, wherein the adaptive ML algorithm is an adaptive cost function and the method comprises:
processing, by the workload detection ML model, ML inputs that include respective deviation values for particular QoS parameters; and
iteratively updating, based on the adaptive cost function, one or more quality control values of the plurality of quality control values after processing the respective deviation values for particular QOS parameters.

6. The method of claim 5, wherein computing the inference outputs comprises:
computing an inference output that includes one or more quality control values that were updated based on the adaptive cost function and at least one of the respective deviation values for particular QoS parameters.

7. The method of claim 1, wherein each of the one or more function call indicators corresponds to an application programming interface (“API”) call and comprises:
an openCL API call;
an openGL API call;
a textureBind API call; and
a Vulkan API call.

8. The method of claim 1, wherein determining the plurality of software indicators comprises:
determining a device state indicator indicating a power state of a display of the user device, wherein the device state indicator is used to generate a DVFS control value with reference to a background task of the application.

9. The method of claim 1, wherein determining the plurality of software indicators comprises:
determining a device state indicator corresponding to a power state of a display of the user device, wherein a bit value of the device state indicator indicates whether the application is a power-critical application.

10. The method of claim 9, wherein generating the DVFS control value comprises:
generating the DVFS control value based on the bit value of the device state indicator and with reference to a background task of the application.

11. A system-on-chip for implementing a workload detection machine-learning (“ML”) model, the system-on-chip comprising:
one or more processing devices; and
one or more non-transitory machine-readable storage devices for storing instructions that are executable by the one or more processing devices to cause performance of operations comprising:
receiving a request to launch an application at a user device that includes the system-on-chip;
determining, based on the request, a plurality of software indicators, the plurality of software indicators comprising an app-launch indicator indicating launch of the application at the user device and one or more function call indicators;
computing, by the workload detection ML model, inference outputs comprising a detected workload type and a plurality of quality control values, wherein the plurality of quality control values is computed by applying an adaptive ML algorithm of the workload detection ML model to each of the plurality of software indicators; and
generating, using the inference outputs, a Dynamic Variable Frequency Signal (“DVFS”) control value for controlling DVFS settings at the system-on-chip based at least on the detected workload type.

12. The system-on-chip of claim 11, wherein the operations further comprise:
for each quality of service (QoS) parameter of a plurality of QoS parameters:
computing a respective deviation value for the QoS parameter;
wherein the respective deviation value is computed based on:
i) a particular quality control value that corresponds to the QoS parameter, and
ii) at least one function call indicator.

13. The system-on-chip of claim 12, wherein generating the DVFS control value comprises:
generating the DVFS control value based on the respective deviation value for a particular QoS parameter.

14. The system-on-chip of claim 12, wherein computing the inference outputs comprises:
processing, by the workload detection ML model, ML inputs corresponding to each function call indicator through a hidden layer of the workload detection ML model,
wherein the ML inputs are processed through the hidden layer in accordance with the adaptive ML algorithm.

15. The system-on-chip of claim 14, wherein the adaptive ML algorithm is an adaptive cost function and the operations further comprise:
processing, by the workload detection ML model, ML inputs that include respective deviation values for particular QoS parameters; and
iteratively updating, based on the adaptive cost function, one or more quality control values of the plurality of quality control values after processing the respective deviation values for particular QoS parameters.

16. The system-on-chip of claim 15, wherein computing the inference outputs comprises:
computing an inference output that includes one or more quality control values that were updated based on the adaptive cost function and at least one of the respective deviation values for particular QOS parameters.

17. The system-on-chip of claim 11, wherein each of the one or more function call indicators corresponds to an application programming interface (“API”) call and comprises:
an openCL API call;
an openGL API call;
a textureBind API call; and
a Vulkan API call.

18. The system-on-chip of claim 11, wherein determining the plurality of software indicators comprises:
determining a device state indicator indicating a power state of a display of the user device, wherein the device state indicator is used to generate a DVFS control value with reference to a background task of the application.

19. The system-on-chip of claim 11, wherein determining the plurality of software indicators comprises:
determining a device state indicator corresponding to a power state of a display of the user device, wherein a bit value of the device state indicator indicates whether the application is a power-critical application.

20. The system-on-chip of claim 19, wherein generating the DVFS control value comprises:
generating the DVFS control value based on the bit value of the device state indicator and with reference to a background task of the application.
